(19) United States
(12) Patent Application Publication
(10) Pub. No.: US 2026/0257952 A1
(43) Pub. Date: Sep. 3, 2026

(54) METHOD AND APPARATUS FOR TREATING WASTEWATER

(71) Applicant: Samsung E&A Co., Ltd., Seoul (KR)

(72) Inventors: Jin Wook CHUNG, Seoul (KR); Ji Yeon HA, Seoul (KR); Joon Jee JEONG, Seoul (KR)

(73) Assignee: Samsung E&A Co., Ltd., Seoul (KR)

(21) Appl. No.: 18/842,827

(22) PCT Filed: May 29, 2024
(86) PCT No.: PCT/KR2024/007311

§ 371 Date: Aug. 30, 2024

(30) Foreign Application Priority Data
Jul. 25, 2023 (KR) 10-2023-0097035

(51) Int. Cl. C02F 9/00; C02F 1/00; C02F 3/12; C02F 3/30; C02F 11/12; C02F 101/16

(52) U.S. Cl. CPC C02F 9/00; C02F 2001/007; C02F 3/1268; C02F 3/301; C02F 3/303; C02F 3/305; C02F 11/12; C02F 2101/16; C02F 2301/08

(57) ABSTRACT

Provided are a method and apparatus for treating wastewater. The method includes a step (S10) of producing primary treated water by passing wastewater containing ammonia nitrogen (NH₄—N) through a first membrane coupled bioreactor and a step (S20) of producing secondary treated water by passing the primary treated water through a second membrane coupled bioreactor, wherein a partial region of the first membrane coupled bioreactor is operated under aerobic conditions and another region of the first membrane coupled bioreactor is operated under anoxic conditions, and the second membrane coupled bioreactor is operated under anoxic conditions.

### TECHNICAL FIELD

This application is based on and claims priority under 35 U.S.C. § 119 to Korean Patent Application No. 10-2023-0097035, filed on Jul. 25, 2023, in the Korean Intellectual Property Office, the disclosure of which is incorporated by reference herein in its entirety.

The disclosure relates to a method and apparatus for treating wastewater. More particularly, the disclosure relates to a method and apparatus for treating wastewater, by which energy and carbon sources used in wastewater treatment may be minimized, and final treated water having a low total nitrogen content may be obtained.

### BACKGROUND ART

In the art, ammonia nitrogen (NH₄—N) in sewage is oxidized to nitrite nitrogen (NO₂—N) and nitrate nitrogen (NO₃—N), through nitrification as shown in Reaction Scheme 1 under aerobic conditions, which are then reduced to nitrogen gas (N₂) in an anoxic state without oxygen through a denitrification process as shown in Reaction Scheme 2, resulting in the removal of ammonia nitrogen from the water system. This system requires excessive aeration energy (4.57 kg-O₂/kg-NH₄—N) and denitrifying carbon sources (3-6 kg-COD/kg-NO₃—N), and thus may be referred to as an energy-consuming nitrogen treatment method.

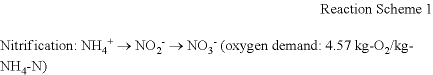

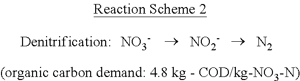

### DISCLOSURE OF INVENTION

### Technical Problem

Provided is a method of treating wastewater, by which energy and carbon sources used in wastewater treatment may be minimized, and final treated water having a low total nitrogen content may be obtained.

Provided is an apparatus for treating wastewater, by which energy and carbon sources used in wastewater treatment may be minimized, and final treated water having a low total nitrogen content may be obtained.

### Solution to Problem

Additional aspects will be set forth in part in the description which follows and, in part, will be apparent from the description, or may be learned by practice of the presented embodiments of the disclosure.

According to an aspect of the disclosure, a method of treating wastewater includes
a step (S10) of producing primary treated water by passing wastewater containing ammonia nitrogen (NH₄—N) through a first membrane coupled bioreactor,
wherein a partial region of the first membrane coupled bioreactor is operated under aerobic conditions and another region of the first membrane coupled bioreactor is operated under anoxic conditions.

In the first membrane coupled bioreactor, oxygen-containing air may be supplied into a membrane, and a region outside the membrane may be operated under anoxic conditions.

The method may further include a step (S20) of producing secondary treated water by passing the primary treated water through a second membrane coupled bioreactor, wherein the second membrane coupled bioreactor may be operated under anoxic conditions.

In the second membrane coupled bioreactor, methane gas may be supplied into a membrane, and a region outside the membrane may be operated under anoxic conditions.

The step (S10) may include a step (S10-1) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions generated in the region outside the membrane, as the inside of the first membrane coupled bioreactor, and a step (S10-2) of converting ammonia nitrogen (NH₄—N) and nitrite nitrogen (NO₂—N) into nitrogen gas (N₂) and nitrate nitrogen (NO₃—N), under anoxic conditions in the first membrane coupled bioreactor.

The step (S10-1) may involve conversion of ammonia nitrogen (NH₄—N) only into nitrite nitrogen (NO₂—N), as shown in Reaction Scheme 3, and in this process, aeration energy may be saved:

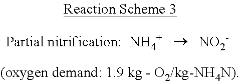

The step (S10-2) may include an anammox reaction in which ammonia nitrogen (NH₄—N) and nitrite nitrogen (NO₂—N) react with each other and are oxidized to nitrogen gas (N₂) and nitrate nitrogen (NO₃—N), as shown in Reaction Scheme 4, and in this process, the carbon source consumed may be reduced as compared to existing biological treatment methods:

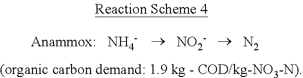

A chemical equivalent overall reaction scheme of the step (S10-1) and the step (S10-2) may be as shown in Reaction Scheme 5:

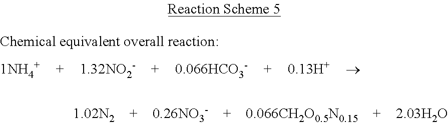

In the step (S10-1), the first membrane coupled bioreactor has a hydraulic retention time of within 4 hours, and the step (S10-1) may be performed in a state in which an average partial pressure of oxygen in oxygen-containing gas inside the membrane mounted in the first membrane coupled bioreactor is maintained in a range of about 17 kPa to about 23.2 kPa.

In the step (S10-1), the average partial pressure of oxygen in oxygen-containing gas may be controlled in conjunction with oxygen utilization efficiency and an oxygen transfer capacity that is calculated on the basis of a concentration CL of dissolved oxygen in a liquid phase in equilibrium with a gas phase in the membrane through a differential pressure-based oxygen transfer model represented by Equation 1:

$$J = K \frac{\frac{{p}_{i n}}{H} - \frac{{p}_{out}}{H}}{ln ( \frac{\frac{{p}_{i n}}{H} - {C}_{L}}{\frac{{p}_{out}}{H} - {C}_{L}} )} \qquad Equation 1$$

wherein, in Equation 1,
J is oxygen transfer capacity per second (mol/m²·sec), K is mass transfer coefficient (m²/sec), Pᵢₙ is oxygen partial pressure (Pa) at an inlet, Pₒᵤₜ is oxygen partial pressure (Pa) at an outlet, H is Henry's law constant (Pa·m²/mol), and C_{L} is concentration (mol/m³) of oxygen in liquid.

The step (S20) may include a step (S20-1) of converting nitrate nitrogen (NO₃—N) into nitrite nitrogen (NO₂—N), under anoxic conditions generated in a region outside the membrane by using methane gas injected into the membrane, as the inside of the second membrane coupled bioreactor, and a step (S20-2) of converting ammonia nitrogen (NH₄—N) and nitrite nitrogen (NO₂—N) into nitrogen gas (N₂), under anoxic conditions in the second membrane coupled bioreactor.

The step (S20-1) may include a DAMO reaction to convert methane gas into methanol, as shown in Reaction Scheme 6, and a reaction to convert nitrate nitrogen (NO₃—N) only into nitrite nitrogen (NO₂—N) by using methanol as a carbon source, as shown in Reaction Scheme 7:

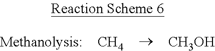

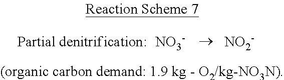

The step (S20-2) may include an anammox reaction in which residual ammonia nitrogen (NH₄—N) and nitrite nitrogen (NO₂—N) react with each other and are oxidized to nitrogen gas (N₂) and nitrate nitrogen (NO₃—N), as shown in Reaction Scheme 8, and in this process, the carbon source consumed may be reduced as compared to existing biological treatment methods:

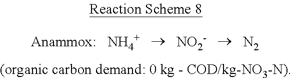

A chemical equivalent overall reaction scheme of process S20-1 and process S20-2 may be as shown in Reaction Scheme 9:

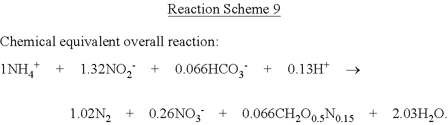

According to another aspect of the disclosure, a method of treating wastewater includes
a step (S100) of producing primary treated water by passing wastewater containing ammonia nitrogen (NH₄—N) through an activated sludge tank,
a step (S200) of producing secondary treated water and first sludge by passing the primary treated water through a first settling tank,
a step (S300) of producing tertiary treated water by passing the secondary treated water through a first two-stage membrane coupled bioreactor,
a step (S400) of producing quaternary treated water and second sludge by passing the tertiary treated water through a second settling tank,
a step (S500) of producing digested sludge by passing the second sludge through an anaerobic digestion tank,
a step (S600) of producing first sludge water and third sludge by passing the digested sludge through a sludge dehydration tank,
a step (S700) of producing second sludge water by passing the first sludge water through a second two-stage membrane coupled bioreactor, and
a step (S800) of mixing the second sludge water with the primary treated water supplied to the step (S200).

The step (S300) may include, as steps performed in a first membrane coupled bioreactor, a step (S310) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions generated in a region outside a membrane, as the inside of the first membrane coupled bioreactor, and a step (S320) of converting ammonia nitrogen (NH₄—N) and nitrite nitrogen (NO₂—N) into nitrogen gas (N₂) and nitrate nitrogen (NO₃—N), under anoxic conditions in the first membrane coupled bioreactor, and may include, as steps performed in a second membrane coupled bioreactor, a step (S330) of converting nitrate nitrogen (NO₃—N) into nitrite nitrogen (NO₂—N), under anoxic conditions in a biofilm formed outside a membrane in the second membrane coupled bioreactor and a step (S340) of converting ammonia nitrogen (NH₄—N) and nitrite nitrogen (NO₂—N) into nitrogen gas (N₂), under anoxic conditions in the second membrane coupled bioreactor.

The step (S310) may be performed in a state in which an average partial pressure of oxygen in oxygen-containing gas inside the membrane mounted in the first membrane coupled bioreactor is maintained in a range of about 17 kPa to about 23.2 kPa.

The step (S700) may include, as steps performed in a third membrane coupled bioreactor, a step (S710) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions generated in a region outside a membrane, as the inside of the third membrane coupled bioreactor, and a step (S720) of converting ammonia nitrogen (NH₄—N) and nitrite nitrogen (NO₂—N) into nitrogen and nitrate nitrogen (NO₃—N), under anoxic conditions in the third membrane coupled bioreactor, and may include, as steps performed in a fourth membrane coupled bioreactor, a step (S730) of converting nitrate nitrogen (NO₃—N) into nitrite nitrogen (NO₂—N) under anoxic conditions generated in a region outside a membrane, as the inside of the fourth membrane coupled bioreactor, and a step (S740) of converting ammonia nitrogen (NH₄—N) and nitrite nitrogen (NO₂—N) into nitrogen, under anoxic conditions in the fourth membrane coupled bioreactor.

The first sludge produced in the step (S200) may be supplied to the anaerobic digestion tank in the step (S500).

Part of the second sludge produced in the step (S400) may be returned to the first two-stage membrane coupled bioreactor in the step (S300).

According to another aspect of the disclosure, an apparatus for treating wastewater includes
a first membrane coupled bioreactor configured to produce primary treated water by treating wastewater containing ammonia nitrogen (NH₄—N), and
a second membrane coupled bioreactor configured to produce secondary treated water by further treating the primary treated water,
wherein the first membrane coupled bioreactor is configured such that a partial region of the first membrane coupled bioreactor is operated under aerobic conditions and another region of the first membrane coupled bioreactor is operated under anoxic conditions, and the second membrane coupled bioreactor is configured to be operated under anoxic conditions.

The first membrane coupled bioreactor may be configured to primarily convert ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and to secondarily convert ammonia nitrogen (NH₄—N) and nitrite nitrogen (NO₂—N) into nitrogen gas (N₂) and nitrate nitrogen (NO₃—N), under anoxic conditions.

The first membrane coupled bioreactor may be configured such that an average partial pressure of oxygen in oxygen-containing gas inside a membrane mounted therein is maintained in a range of about 17 kPa to about 23.2 kPa.

The second membrane coupled bioreactor may be configured to primarily convert nitrate nitrogen (NO₃—N) into nitrite nitrogen (NO₂—N), under anoxic conditions, and to secondarily convert ammonia nitrogen (NH₄—N) and nitrite nitrogen (NO₂—N) into nitrogen gas (N₂), under anoxic conditions.

According to another aspect of the disclosure, an apparatus for treating wastewater includes
an activated sludge tank configured to produce primary treated water by treating wastewater containing ammonia nitrogen (NH₄—N) and having a chemical oxygen demand (COD),
a first settling tank configured to produce secondary treated water and first sludge by partial settling of the primary treated water,
a first two-stage membrane coupled bioreactor configured to produce tertiary treated water by further treating the secondary treated water,
a second settling tank configured to produce quaternary treated water and second sludge by partial settling of the tertiary treated water,
an anaerobic digestion tank configured to produce digested sludge by partially digesting the second sludge,
a sludge dehydration tank configured to produce first sludge water and third sludge by partially dehydrating the digested sludge, and
a second two-stage membrane coupled bioreactor configured to produce second sludge water by further treating the first sludge water.

The apparatus may be configured such that the second sludge water is mixed with the wastewater supplied to the first settling tank.

The first two-stage membrane coupled bioreactor may include a first membrane coupled bioreactor and a second membrane coupled bioreactor that are connected to each other in series, the second two-stage membrane coupled bioreactor may include a third membrane coupled bioreactor and a fourth membrane reactor that are connected to each other in series, each of the first membrane coupled bioreactor and the third membrane coupled bioreactor may be configured to primarily convert ammonia nitrogen (NH₄—N) into nitrite nitrogen (NO₂—N), not into nitrate nitrogen (NO₃—N), through partial oxidization of the ammonia nitrogen (NH₄—N), under aerobic conditions generated in a region outside a membrane, as the inside of each bioreactor, and to secondarily convert ammonia nitrogen (NH₄—N) and nitrite nitrogen (NO₂—N) into nitrogen and nitrate nitrogen (NO₃—N), under anoxic conditions in each bioreactor, and each of the second membrane coupled bioreactor and the fourth membrane coupled bioreactor may be configured to primarily convert nitrate nitrogen (NO₃—N) into nitrite nitrogen (NO₂—N), under anoxic conditions generated in a region outside a membrane, as the inside of each bioreactor, and to secondarily convert ammonia nitrogen (NH₄—N) and nitrite nitrogen (NO₂—N) into nitrogen gas (N₂), under anoxic conditions in each bioreactor.

In the first membrane coupled bioreactor, an average partial pressure of oxygen in oxygen-containing gas inside the membrane mounted therein may be maintained in a range of about 17 kPa to about 23.2 kPa.

The apparatus may be configured such that the first sludge produced in the first settling tank is supplied to the anaerobic digestion tank.

The apparatus may be configured such that part of the second sludge produced in the second settling tank is returned to the first two-stage membrane coupled bioreactor.

### Advantageous Effects of Invention

According to a method and apparatus for treating wastewater, according to an embodiment of the disclosure, energy and carbon sources used in wastewater treatment may be minimized and final treated water having a low total nitrogen content may be obtained.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a schematic view of a method and apparatus for treating wastewater, according to an embodiment;

FIG. 2 is a view illustrating mass transfer paths through a membrane of a first membrane coupled bioreactor and the vicinity of the membrane;

FIG. 3 is a diagram illustrating mass transfer paths through a membrane of a first membrane coupled bioreactor and the vicinity of the membrane, as well as reactions between the materials;

FIG. 4 is a diagram illustrating mass transfer paths through a membrane of a second membrane coupled bioreactor of the apparatus of FIG. 1 and the vicinity of the membrane, as well as reactions between the materials;

FIG. 5 is a schematic view of a method and apparatus for treating wastewater, according to another embodiment;

FIG. 6 is a graph showing simulation results showing that nitrite accumulation occurred smoothly in a bioreactor, as a result of treatment of wastewater containing ammonia nitrogen (NH₄—N) at a high concentration (1,000 ppm) or higher, such as landfill leachate or livestock wastewater;

FIG. 7 is a graph showing simulation results showing that nitrite accumulation in a bioreactor was impossible, as a result of treatment of wastewater containing ammonia nitrogen (NH₄—N) at a low concentration (50 ppm or less), such as sewage; and

FIG. 8 is a graph showing the effects of two control methods proposed to stably oxidize NH₄ to NO₂ while suppressing NO₃ production upon low-load NH₄ inflow in a first membrane coupled bioreactor.

### MODE FOR THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a method of treating wastewater, according to an embodiment of the disclosure, will be described in detail.

“Wastewater” as used herein refers to untreated wastewater (i.e., raw water or influent water).

In addition, “treated water” as used herein refers to treated wastewater that, at all stages, through the removal of impurities in untreated wastewater, contains impurities in a smaller amount than in the untreated wastewater.

In addition, “to-be-treated water” as used herein refers to water to be treated in a certain stage, and the to-be-treated water in each process has different treatment rates.

In addition, “first membrane coupled bioreactor” and “third membrane coupled bioreactor” as used herein refer to membrane aerated biofilm reactors (MABRs).

In addition, “second membrane coupled bioreactor” and “fourth membrane coupled bioreactor” as used herein refer to membrane biofilm reactors (MBfRs).

In addition, “parts per million (ppm)” as used herein refers to mg/L (milligram per liter).

In addition, “ammonia nitrogen (NH₄—N)” as used herein refers to nitrogen contained in ammonium ions (NH₄⁺) or ammonium ions themselves, in some embodiments.

In addition, “nitrite nitrogen (NO₂—N)” as used herein refers to nitrogen contained in nitrite ions (NO₂) or nitrite ions themselves, in some embodiments.

In addition, “nitrate nitrogen (NO₃—N)” refers to nitrogen contained in nitrate ions (NO₃) or nitrate ions themselves, in some embodiments.

In addition, as used herein, “front end or front end portion” refers to a portion or end portion relatively positioned in a reverse direction to the flow direction of wastewater, and “rear end or rear end portion” refers to a portion or end portion relatively positioned in a forward direction with respect to the flow direction of wastewater.

In addition, “film” and “membrane” as used herein have the same meaning.

An apparatus and method for treating wastewater, according to embodiments of the disclosure, have been developed to improve energy-consuming processes represented by Reaction Schemes 1 and 2, which are a combination of: a partial nitritation process of performing a reaction as shown in Reaction Scheme 3 to convert half of ammonia nitrogen (NH₄—N) into nitrite nitrogen (NO₂—N), under aerobic conditions; and an anaerobic ammonia oxidation (ANAMMOX) process of performing a reaction as shown in Reaction Scheme 4 to convert the remaining half of ammonia nitrogen (NH₄—N) and the nitrite nitrogen (NO₂—N), which is produced through the partial nitritation process of ammonia nitrogen (NH₄—N), into nitrogen (N₂) gas, through a reaction therebetween under anoxic conditions. In the partial nitritation process, ammonia nitrogen (NH₄—N) is partially oxidized only to nitrite nitrogen (NO₂—N), thus saving on oxygen consumption by up to 63%, and a denitrification process is not used, thus removing nitrogen from the water system without the supply of an external carbon source.

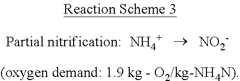

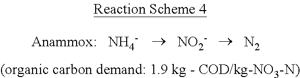

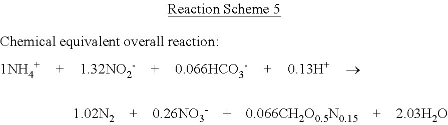

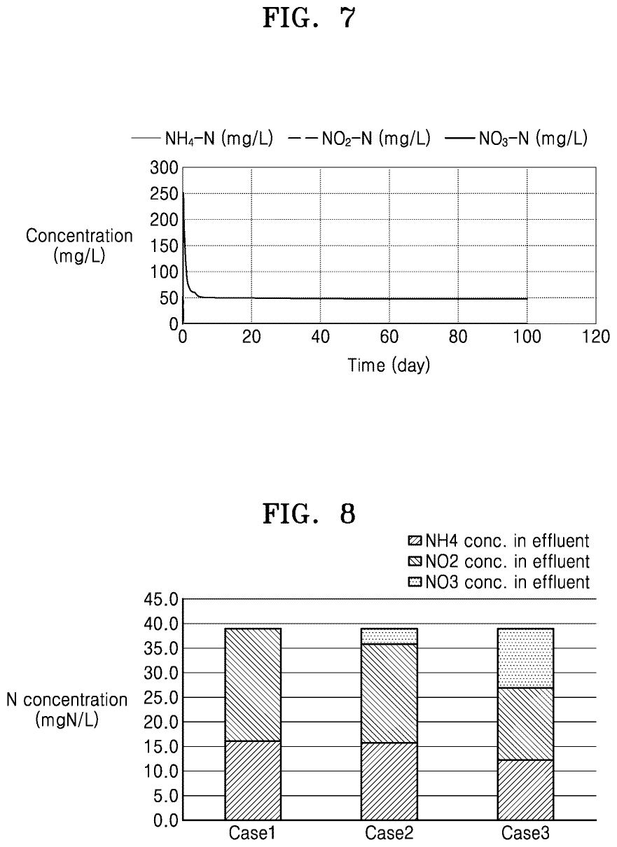

For this anammox reaction, nitrite oxidizing bacteria (NOB) must be inhibited such that nitrite nitrogen (NO₂—N) produced after the partial nitritation reaction is not oxidized to nitrate nitrogen (NO₃—N). Such inhibition may easily occur under conditions of a high concentration of incoming ammonia nitrogen, and thus is mainly applied to sewage/wastewater containing a high concentration of nitrogen, such as anaerobic digestion return water (see FIG. 6). In contrast, the inventors of the disclosure had found that it was difficult to inhibit NOB when the concentration of incoming ammonia nitrogen (NH₄—N) was low (see FIG. 7), and as a result of having made intensive efforts, discovered a novel method of inhibiting the activity of NOB even under such circumstances, thus completing the disclosure.

The method of treating wastewater, according to an embodiment of the disclosure, includes a step (S10) of producing primary treated water by passing wastewater containing ammonia nitrogen (NH₄—N) through a first membrane coupled bioreactor and a step (S20) of producing secondary treated water by passing the primary treated water through a second membrane coupled bioreactor.

The wastewater treated in process S10 may contain ammonia nitrogen (NH₄—N) at a concentration of about 30 mg/L to about 50 mg/L.

A partial region of the first membrane coupled bioreactor may be operated under aerobic conditions and another region of the first membrane coupled bioreactor may be operated under anoxic conditions. Particularly, the step (S10) may include a step (S10-1) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and a step (S10-2) of converting ammonia nitrogen (NH₄—N) and nitrite nitrogen (NO₂—N) into nitrogen and nitrate nitrogen (NO₃—N), under anoxic conditions.

In addition, the step (S10-1) may be performed in a state in which an average partial pressure of oxygen inside a membrane mounted in the first membrane coupled bioreactor is maintained in a range of about 17 kPa to about 23.2 kPa.

The oxygen-containing gas may be air or oxygen.

In the step (S10-1), the average partial pressure of oxygen in the oxygen-containing gas may be controlled in conjunction with oxygen utilization efficiency and an oxygen transfer capacity that is calculated on the basis of a concentration C_{L} of dissolved oxygen in a liquid phase in equilibrium with a gas phase in the membrane through a differential pressure-based oxygen transfer model represented by Equation 1:

$$J = K \frac{\frac{{p}_{i n}}{H} - \frac{{p}_{out}}{H}}{ln ( \frac{\frac{{p}_{i n}}{H} - {C}_{L}}{\frac{{p}_{out}}{H} - {C}_{L}} )} \qquad Equation 1$$

wherein, in Equation 1,
J is oxygen transfer capacity per second (mol/m²·sec), K is mass transfer coefficient (m²/sec), Pᵢₙ is oxygen partial pressure (Pa) at an inlet, Pₒᵤₜ is oxygen partial pressure (Pa) at an outlet, H is Henry's law constant (Pa·m²/mol), and C_{L} is concentration (mol/m³) of oxygen in liquid.

The oxygen transfer capacity may be represented by Equation 2.

$$Oxygen transfer capacity ( mg {O}_{2} \text{/L/hr} ) = K \times a \times ( {C}^{*} - {C}_{1} ) \qquad Equation 2$$

In Equation 2, K is oxygen transfer coefficient (cm/hr), a is gas-liquid contact area per unit volume of a membrane (cm²/cm³), K x a is volumetric oxygen transfer coefficient (1/hr), C* is concentration of dissolved oxygen in a liquid phase in equilibrium with a gas phase in the membrane (mg/L), and C₁ is concentration of dissolved oxygen in bulk liquid (mg/L).

The oxygen-containing gas supplied to the membrane may be air, and the concentration of oxygen in the air supplied to an inlet of the membrane may be 23% (=230,000 mg/L), and the concentration of oxygen in liquid does not exceed about 8 mg/L, which is the maximum saturation concentration in water. Assuming that the oxygen concentration at the outlet of the membrane is 21%, the concentration of oxygen in liquid may be about 1/28,000 of the concentration of oxygen supplied by the oxygen-containing gas by Henry's law, and insignificantly affects the oxygen transfer capacity per second.

Thus, in Equation 1, when “pᵢₙ/H−C_{L}” is replaced with “pᵢₙ/H” and “pₒᵤₜ/H−C_{L}” is replaced with “pₒᵤₜ/H,” Equation 1 is simplified to Equation 1′ and Equation 1″.

$$J = \frac{K}{H} \frac{{p}_{i n} - {p}_{out}}{ln ( \frac{{p}_{i n}}{{p}_{out}} )} \qquad Equation {1}^{′}$$

$$J = \frac{K}{H} {M}_{l m} ( {p}_{i n} , {p}_{out} ) \qquad Equation {1}^{″}$$

In Equation 1″,
Mₗₘ(pᵢₙ, pₒᵤₜ) refers to the logarithmic mean of oxygen partial pressure at the inlet and oxygen partial pressure at the outlet, which is referred to as the average partial pressure of oxygen in the oxygen-containing gas.

Thus, the transfer capacity of oxygen supplied to liquid through the membrane may be controlled in conjunction with pressures at the inlet and the outlet of the membrane, as shown in Equation 1, Equation 1′, and Equation 1″.

The second membrane coupled bioreactor may be operated under anoxic conditions. Particularly, the step (S20) may include a step (S20-1) of converting nitrate nitrogen (NO₃—N) into nitrite nitrogen (NO₂—N), under anoxic conditions, and a step (S20-2) of converting ammonia nitrogen (NH₄—N) and nitrite nitrogen (NO₂—N) into nitrogen gas (N₂), under anoxic conditions.

The step (S20-1) may include a DAMO reaction to convert methane gas into methanol, as shown in Reaction Scheme 6, and a reaction to convert nitrate nitrogen (NH₄—N) only into nitrite nitrogen (NO₂—N) by using methanol as a carbon source, as shown in Reaction Scheme 7:

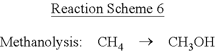

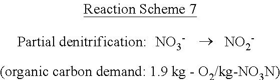

The step (S20-2) may include an anammox reaction in which ammonia nitrogen (NH₄—N) and nitrite nitrogen (NO₂—N) react with each other and are oxidized to nitrogen gas (N₂) and nitrate nitrogen (NO₃—N), as shown in Reaction Scheme 8, and in this process, the carbon source consumed may be reduced as compared to existing biological treatment methods:

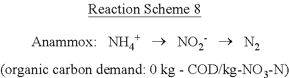

A chemical equivalent overall reaction scheme of the step (S20-1) and the step (S20-2) is as shown in Reaction Scheme 9:

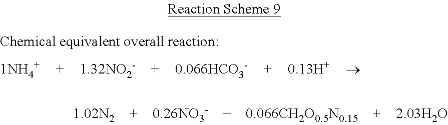

An apparatus and method for treating wastewater, according to another embodiment of the disclosure, include a step (S100) of producing primary treated water by passing wastewater containing ammonia nitrogen (NH₄—N) through an activated sludge tank, a step (S200) of producing secondary treated water and first sludge by passing the primary treated water through a first settling tank, a step (S300) of producing tertiary treated water by passing the secondary treated water through a first two-stage membrane coupled bioreactor, a step (S400) of producing quaternary treated water and second sludge by passing the tertiary treated water through a second settling tank, a step (S500) of producing digested sludge by passing the second sludge through an anaerobic digestion tank, a step (S600) of producing first sludge water and third sludge by passing the digested sludge through a sludge dehydration tank, a step (S700) of producing second sludge water by passing the first sludge water through a second two-stage membrane coupled bioreactor, and a step (S800) of mixing the second sludge water with the primary treated water supplied to the step (S200).

The wastewater treated in the step (S10) may contain ammonia nitrogen (NH₄—N) at a concentration of about 30 mg/L to about 50 mg/L and have a chemical oxygen demand (COD) at a concentration of about 300 mg/L to 1,000 mg/L.

The step (S300) may include, as steps performed in a first membrane coupled bioreactor, a step (S310) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions and a step (S320) of converting ammonia nitrogen (NH₄—N) and nitrite nitrogen (NO₂—N) into nitrogen gas and nitrate nitrogen (NO₃—N), under anoxic conditions, and may include, as steps performed in a second membrane coupled bioreactor, a step (S330) of converting nitrate nitrogen (NO₃—N) into nitrite nitrogen (NO₂—N), under anoxic conditions and a step (S340) of converting ammonia nitrogen (NH₄—N) and nitrite nitrogen (NO₂—N) into nitrogen gas (N₂), under anoxic conditions.

The first sludge produced in the step (S200) may be supplied to the anaerobic digestion tank in the step (S500).

The step (S310) may be performed in a state in which an average partial pressure of oxygen inside a membrane mounted in the first membrane coupled bioreactor is maintained in a range of about 17 kPa to about 23.2 kPa. When the average partial pressure of oxygen inside the membrane installed in the first membrane coupled bioreactor is maintained in a range of about 17 kPa to about 23.2 kPa, the concentration of dissolved oxygen diffused into a biofilm formed on a surface of the membrane may be adjusted to 0.5 mg/L or less.

In the step (S310), the average partial pressure of oxygen may be controlled in conjunction with oxygen utilization efficiency and oxygen transfer capacity that is calculated on the basis of a concentration (C*) of dissolved oxygen in a liquid phase in equilibrium with a gas phase in the membrane, as shown in Equation 1.

Part of the second sludge produced in the step (S400) may be returned to the first two-stage membrane coupled bioreactor in the step (S300).

The step (S700) may include, as steps performed in a third membrane coupled bioreactor, a step (S710) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions and a step (S720) of converting ammonia nitrogen (NH₄—N) and nitrite nitrogen (NO₂—N) into nitrogen gas and nitrate nitrogen (NO₃—N), under anoxic conditions, and may include, as steps performed in a fourth membrane coupled bioreactor, a step (S730) of converting nitrate nitrogen (NO₃—N) into nitrite nitrogen (NO₂—N), under anoxic conditions and a step (S740) of converting ammonia nitrogen (NH₄—N) and nitrite nitrogen (NO₂—N) into nitrogen gas (N₂), under anoxic conditions.

Hereinafter, an apparatus for treating wastewater, according to an embodiment of the disclosure, will be described in detail with reference to the accompanying drawings.

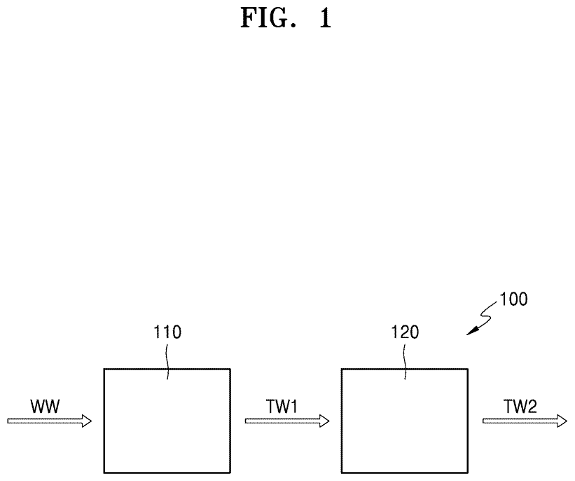

FIG. 1 is a schematic view of a method and apparatus 100 for treating wastewater, according to an embodiment.

Referring to FIG. 1, the apparatus 100 according to an embodiment of the disclosure includes a first membrane coupled bioreactor 110 and a second membrane coupled bioreactor 120.

The first membrane coupled bioreactor 110 may be configured to produce primary treated water TW1 by treating wastewater WW containing ammonia nitrogen (NH₄—N). In this regard, the wastewater WW may contain ammonia nitrogen (NH₄—N) at a concentration of about 30 mg/L to about 50 mg/L.

The second membrane coupled bioreactor 120 may be configured to produce secondary treated water TW2 by further treating the primary treated water TW1.

The first membrane coupled bioreactor 110 may be configured to be operated sequentially under aerobic conditions and under anoxic conditions.

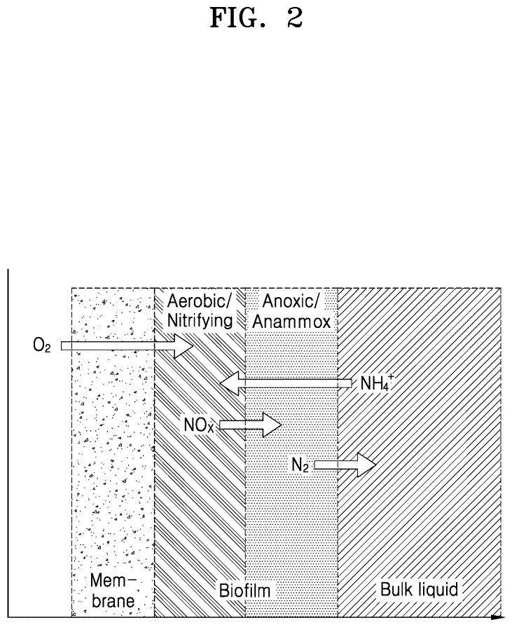

Hereinafter, the configuration, operation and effect of the first membrane coupled bioreactor 110 will be described in detail with reference to FIGS. 2 and 3.

FIG. 2 is a view illustrating a membrane mounted in the first membrane coupled bioreactor 110 of the apparatus 100 of FIG. 1 and the principle of inhibiting the activity of nitrite oxidizing bacteria through the membrane, FIG. 2 is a view illustrating mass transfer paths through a membrane of the first membrane coupled bioreactor and the vicinity of the membrane, and FIG. 3 is a view illustrating mass transfer paths through the membrane of the first membrane coupled bioreactor and the vicinity of the membrane, as well as reactions between the materials.

First, referring to FIG. 2, the first membrane coupled bioreactor 110 is configured such that oxygen-containing gas is supplied from the outside to the inside of the membrane through a plurality of gas inlets and a biofilm is grown on a surface of the membrane. Particularly, when oxygen-containing gas is supplied to liquid (i.e., wastewater) through the membrane, a biofilm may be formed close to the surface of the membrane.

Particularly, referring to FIGS. 2 and 3, when oxygen-containing gas is supplied to liquid (i.e., wastewater) through the membrane, ammonia oxidizing bacteria (AOB) or nitrifying bacteria form a primary biofilm close to the surface of the membrane (referred to as a “nitrifier”), under aerobic conditions, and anammox bacteria form a secondary biofilm outside the membrane (i.e., the primary biofilm side), under anoxic conditions (referred to as “AMX”), and accordingly, nitrite ions (NO₂) generated in the primary biofilm immediately react with ammonium ions (NH₄⁺) in the secondary biofilm and are converted into nitrogen gas (N₂).

More particularly, referring back to FIG. 3, the first membrane coupled bioreactor 110 primarily converts ammonia nitrogen (NH₄—N) (i.e., ammonium ions) into nitrite nitrogen (NO₂—N) (i.e., nitrite ions), not into nitrate nitrogen (NO₃—N) (i.e., nitrate ions), through partial oxidization of the ammonia nitrogen (NH₄—N), under aerobic conditions, and secondarily converts ammonia nitrogen (NH₄—N) (i.e., ammonium ions) and nitrite nitrogen (NO₂—N) (i.e., nitrite ions) into nitrogen gas (N₂) and nitrate nitrogen (NO₃—N) (i.e., nitrate ions), under anoxic conditions.

In addition, the first membrane coupled bioreactor 110 may be configured such that the average partial pressure of oxygen in the membrane mounted therein is maintained in a range of about 17 kPa to about 23.2 kPa. The growth of a biofilm on the surface of the membrane as described above depends on the concentration of a substrate (i.e., ammonium ions) outside (i.e., bulk liquid) the membrane, and oxygen concentration and oxygen pressure inside the membrane. In addition, important factors inside the membrane are the flow rate of oxygen-containing gas supplied into the membrane and the average partial pressure of oxygen inside the membrane. However, when wastewater containing a low concentration of ammonia nitrogen (NH₄—N) is introduced, the only way to be able to inhibit the growth of nitrite oxidizing bacteria (NOB) is to control the concentration of dissolved oxygen. In contrast, as described above, when the average partial pressure of oxygen inside the membrane mounted in the first membrane coupled bioreactor 110 is maintained in a range of about 17 kPa to about 23.2 kPa, the concentration of dissolved oxygen diffused into a biofilm formed on the surface of the membrane may be adjusted to 0.5 mg/L or less, and when this method is used, the concentration of dissolved oxygen diffused into the biofilm may be continuously adjusted to 0.5 mg/L or less, thus enabling continuous operation.

The average partial pressure of oxygen may be controlled in conjunction with oxygen utilization efficiency and oxygen transfer capacity that is calculated on the basis of the concentration (C*) of dissolved oxygen in a liquid phase in equilibrium with a gas phase in the membrane, as shown in Equation 1.

The second membrane coupled bioreactor 120 may be configured to be operated under anoxic conditions.

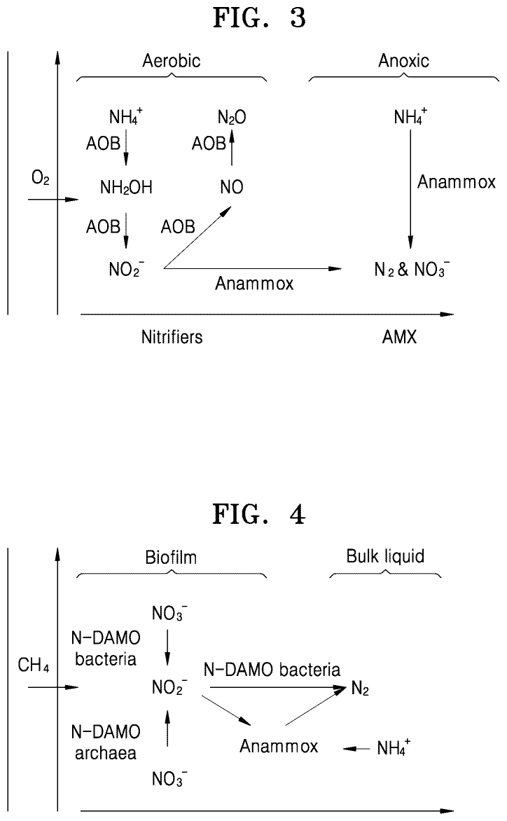

Hereinafter, the configuration, operation and effect of the second membrane coupled bioreactor 120 will be described in detail with reference to FIG. 4.

FIG. 4 is a view illustrating mass transfer paths through a membrane installed in the second membrane coupled bioreactor 120 of the apparatus 100 of FIG. 1 and the vicinity of the membrane, as well as reactions between the materials.

Referring to FIG. 4, the second membrane coupled bioreactor 120 may be configured to primarily convert nitrate nitrogen (NO₃—N) (i.e., nitrate ions) into nitrite nitrogen (NO₂—N) (i.e., nitrite ions), under anoxic conditions in a biofilm, and to secondarily convert ammonia nitrogen (NH₄—N) (i.e., ammonium ions) and nitrite nitrogen (NO₂—N) (i.e., nitrite ions) into nitrogen gas (N₂), under anoxic conditions in bulk liquid. Particularly, the treated water TW1 discharged from the first membrane coupled bioreactor 110 contains all of ammonia nitrogen (NH₄—N), nitrite nitrogen (NO₂—N), and nitrate nitrogen (NO₃—N) produced by the ANAMMOX reaction. In the second membrane coupled bioreactor 120, biogas generated after anaerobic digestion is supplied into the membrane instead of oxygen-containing gas, wherein CH₄ gas contained in the biogas is used as an electron donor. When CH₄ gas permeates into an outer surface of the membrane, microorganisms involved in a denitrifying anaerobic methane oxidation (DAMO) reaction that converts CH₄ gas into methanol become dominant and form a DAMO biofilm on the surface of the membrane. Methanol converted by microorganisms involved in the DAMO reaction may be used as a denitrifying carbon source, and by using this, nitrate nitrogen (NO₃—N) discharged from the first membrane coupled bioreactor 110 may be reduced to nitrite nitrogen (NO₂—N) through partial denitrification. ANAMMOX microorganisms which use, as substrates, residual ammonia nitrogen (NH₄—N) present in the bulk liquid and the nitrite nitrogen (NO₂—N) reduced by DAMO, may grow outside the DAMO biofilm, and accordingly, an ANAMMOX biofilm may be formed on a surface of the DAMO biofilm. Through this, all remaining nitrogen components are converted into nitrogen gas (N₂) and removed from the water system, and a nitrogen removal rate may be maximized.

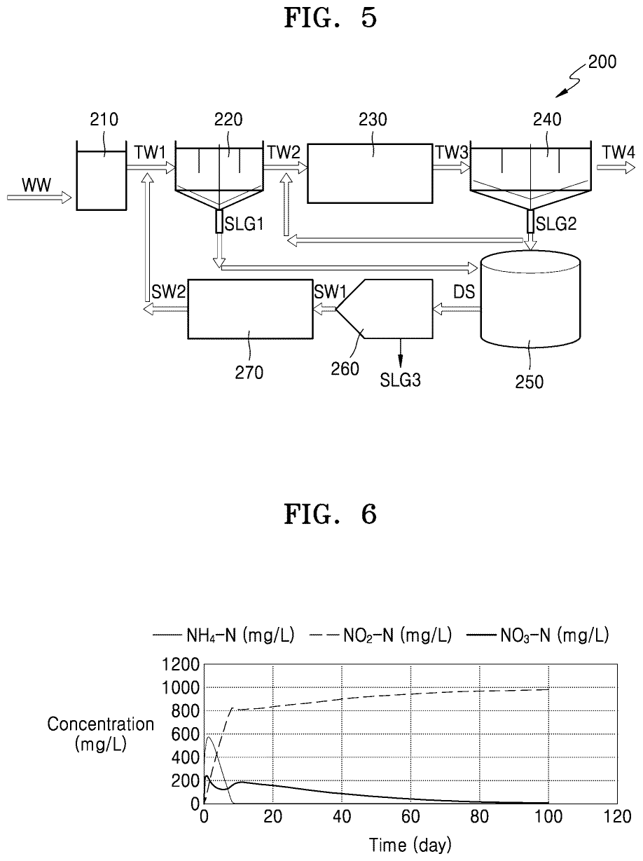

Hereinafter, an apparatus 200 for treating wastewater, according to another embodiment of the disclosure, will be described in detail with reference to FIG. 5.

Referring to FIG. 5, the apparatus 200 for treating wastewater, according to another embodiment of the disclosure, includes an activated sludge tank 210, a first settling tank 220, a first two-stage membrane coupled bioreactor 230, a second settling tank 240, an anaerobic digestion tank 250, a sludge dehydration tank 260, and a second two-stage membrane coupled bioreactor 270.

The activated sludge tank 210 may be configured to produce primary treated water TW1 by treating wastewater WW containing ammonia nitrogen (NH₄—N) and having a COD. The activated sludge tank 210 serves to remove a COD. In this regard, the wastewater WW may contain ammonia nitrogen (NH₄—N) at a concentration of about 30 mg/L to about 50 mg/L and have a COD at a concentration of about 300 mg/L to about 1,000 mg/L.

The first settling tank 220 may be configured to produce secondary treated water TW2 and first sludge SLG1 by partial settling of the primary treated water TW1.

In addition, the apparatus 200 for treating wastewater may be configured such that the first sludge SLG1 produced in the first settling tank 220 is supplied to the anaerobic digestion tank 250.

The first two-stage membrane coupled bioreactor 230 may be configured to produce tertiary treated water TW3 by further treating the secondary treated water TW2.

The first two-stage membrane coupled bioreactor 230 may include a first membrane coupled bioreactor (not shown) and a second membrane coupled bioreactor (not shown) that are connected to each other in series.

The first membrane coupled bioreactor may be configured to primarily convert ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and to secondarily convert ammonia nitrogen (NH₄—N) and nitrite nitrogen (NO₂—N) into nitrogen and nitrate nitrogen (NO₃—N), under anoxic conditions.

The first membrane coupled bioreactor may be configured such that the average partial pressure of oxygen in a membrane mounted therein is maintained at less than 20 kPa.

The average partial pressure of oxygen may be controlled in conjunction with oxygen utilization efficiency and oxygen transfer capacity that is calculated on the basis of the concentration (C*) of dissolved oxygen in a liquid phase in equilibrium with a gas phase in the membrane, as shown in Equation 1.

In addition, the first membrane coupled bioreactor may have the same configuration, operation and effect as the first membrane coupled bioreactor 110 provided in the apparatus 100 for treating wastewater of FIG. 1, and thus a detailed description thereof is not provided herein.

The second membrane coupled bioreactor may be configured to primarily convert nitrate nitrogen (NO₃—N) into nitrite nitrogen (NO₂—N), under anoxic conditions, and secondarily convert ammonia nitrogen (NH₄—N) and nitrite nitrogen (NO₂—N) into nitrogen, under anoxic conditions. The second membrane coupled bioreactor may have the same configuration, operation and effect as the second membrane coupled bioreactor 120 provided in the apparatus 100 for treating wastewater of FIG. 1, and thus a detailed description thereof is not provided herein.

The second settling tank 240 may be configured to produce quaternary treated water TW4 and second sludge SLG2 by partial settling of the tertiary treated water TW3.

In addition, the apparatus 200 for treating wastewater may be configured such that part of the second sludge SLG2 produced in the second settling tank 240 is returned to the first two-stage membrane coupled bioreactor 230.

The anaerobic digestion tank 250 may be configured to produce digested sludge DS by partial digestion of the second sludge SLG2.

The sludge dehydration tank 260 may be configured to produce first sludge water SW1 and third sludge SLG3 by partial dehydration of the digested sludge DS.

The second two-stage membrane coupled bioreactor 270 may be configured to produce second sludge water SW2 by further treating the first sludge water SW1.

The second two-stage membrane coupled bioreactor 270 may include a third membrane coupled bioreactor (not shown) and a fourth membrane coupled bioreactor (not shown) that are connected to each other in series.

The third membrane coupled bioreactor may be configured to primarily convert ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and to secondarily convert ammonia nitrogen (NH₄—N) and nitrite nitrogen (NO₂—N) into nitrogen gas (N₂) and nitrate nitrogen (NO₃—N), under anoxic conditions. The third membrane coupled bioreactor may have the same configuration, operation and effect as the first membrane coupled bioreactor 110 provided in the apparatus 100 for treating wastewater of FIG. 1, and thus a detailed description thereof is not provided herein.

The fourth membrane coupled bioreactor may be configured to primarily convert nitrate nitrogen (NO₃—N) into nitrite nitrogen (NO₂—N), under anoxic conditions, and to secondarily convert ammonia nitrogen (NH₄—N) and nitrite nitrogen (NO₂—N) into nitrogen gas (N₂), under anoxic conditions. The fourth membrane coupled bioreactor may have the same configuration, operation and effect as the second membrane coupled bioreactor 120 provided in the apparatus 100 for treating wastewater of FIG. 1, and thus a detailed description thereof is not provided herein.

Hereinafter, the disclosure will be described in further detail with reference to the following examples. However, these examples are not intended to limit the disclosure.

### Experimental Examples 1 and 2: Simulation of Wastewater Treatment

The treatment of wastewater containing ammonia nitrogen (NH₄—N) at a high concentration (1,000 ppm or more), such as landfill leachate or livestock wastewater, is simulated by using GPS-X, which is the first commercially released dynamic sewage/wastewater and purified water treatment simulator, and the results thereof are illustrated as a graph in FIG. 6. In addition, the treatment of wastewater containing ammonia nitrogen (NH₄—N) at a low concentration (50 ppm or less), such as sewage, was simulated by using GPS-X, and the results thereof are illustrated as a graph in FIG. 7. Simulation conditions are as shown in Table 1. The version used in these simulations was GPS-X 8.1.0, and the model used was MANTIS2. MANTIS2 is a new integrated model that integrates the biological, physical and chemical processes most commonly observed in sewage/wastewater treatment facilities, and is a model developed by Hydromantis which developed GPS-X.

TABLE 1

| | Experimental example 1 | Experimental example 2 |
|---|---|---|
| | Treatment of wastewater | Treatment of wastewater |
| | containing ammonia nitrogen | containing ammonia nitrogen |
| | (NH₄—N) at high concentration | (NH₄—N) at low concentration |
| | (1,000 ppm or more) (FIG. 6) | (50 ppm or less) (FIG. 7) |
| Flow rate of wastewater | 2000 | 2000 |
| (m³/day) | | |
| Concentration (mg/L) of | 1000 | 50 |
| ammonia nitrogen in | | |
| wastewater | | |
| Volume (m³) of two-stage | 1000 | 1000 |
| membrane coupled | | |
| bioreactor | | |
| Hydraulic retention time | 6 | 6 |
| (hr) of two-stage | | |
| membrane coupled | | |
| bioreactor | | |
| Volume (m³) of settling | 300 | 300 |
| tank | | |
| Depth (m) of settling tank | 3 | 3 |
| Flow rate (m³/day) of | 40 | 40 |
| sludge discharged from | | |
| settling tank | | |
| Flow rate (m³/day) of | 2000 | 2000 |
| sludge returned to | | |
| two-stage membrane coupled | | |
| bioreactor in sludge | | |
| discharged from settling | | |
| tank | | |

Referring to FIG. 6, it was confirmed that, when the concentration of ammonia nitrogen in wastewater was high, a high concentration of nitrite nitrogen (NO₂—N) accumulated easily due to the inhibition and washout of nitrite oxidizing bacteria. In contrast, referring to FIG. 7, it was confirmed that, when the concentration of ammonia nitrogen in wastewater was low, inhibition of the activity of nitrite oxidizing bacteria was insignificant, making it difficult for nitrite nitrogen (NO₂—N) to accumulate, and most nitrite nitrogen (NO₂—N) was converted to nitrate nitrogen.

### Experimental Example 3: Simulation of Wastewater Treatment

To satisfy the production ratio of ammonia to nitrite, which is a condition for an anammox reaction, control is needed to inhibit the selective growth of ammonia oxidizing bacteria (AOB), i.e., the growth of nitrite oxidizing bacteria (NOB). There are three methods to inhibit NOB: 1) high concentration of influent free ammonia (FA); 2) low concentration of dissolved oxygen (DO); and 3) short hydraulic retention time (HRT).

In the case of high-concentration ammonia treatment, the growth of NOB is inhibited by a high FA concentration without any other control methods, thus enabling the production of nitrite. However, in the case of low-concentration ammonia treatment, the aforementioned two other control methods are required to produce nitrite due to a low FA concentration.

A membrane coupled bioreactor was proposed as an apparatus to implement the two control methods, and the feasibility thereof was verified through simulation. The results thereof are shown in Table 2 and FIG. 8.

TABLE 2

| | Case 1 | Case 2 | Case 3 |
|---|---|---|---|
| Hydraulic retention time (hr) | 3 | 3 | 4 |
| Log mean pressure (kPa) | 23.1 | 24.5 | 23.1 |
| Inlet air pressure (kPa) | 160 | 170 | 160 |
| Outlet air pressure (kPa) | 150 | 160 | 150 |
| NH₄ conc. in effluent (mgN/L) | 16.2 | 15.8 | 12.3 |
| NO₂ conc. in effluent (mgN/L) | 22.8 | 20.1 | 14.7 |
| NO₃ conc. in effluent (mgN/L) | 0.0 | 3.2 | 11.8 |

Referring to Table 2, NH₄, NO₂ and NO₃ conc. in effluent are the concentrations of NH₄, NO₂ and NO₃ contained in treated water when simulated for each case. As shown in above table, it was confirmed that, even when the concentration of influent ammonia is low (50 mgN/L), it was possible to stably oxidize NH₄ to NO₂ while inhibiting the production of NO₃, by controlling inlet/outlet pressure and HRT. FIG. 8 illustrates the NH₄ conc., NO₂ conc, and NO₃ conc. in effluent of Table 2 as a stacked bar chart for each case. Particularly, FIG. 8 is a graph showing the effect of a control method (1: Long mean pressure control, 2: HRT control) proposed to stably oxidize NH₄ to NO₂ while inhibiting the production of NO₃, upon the inflow of low-load NH₄ in a first membrane coupled bioreactor.

In FIG. 8, when incoming ammonia concentration is 40 mgN/L, Case 1 is a case in which operation is performed by controlling HRT to 3 hr and controlling the inlet/outlet air pressures of a membrane to 160/150 kPa. In Case 1, Log mean pressure is a value calculated through Equation 1. Case 2 is a case in which the inlet/outlet air pressures of Case 1 is changed to 170/160 kPa, and Case 3 is a case in which the HRT of Case 1 is changed.

### Example 1: Simulation of Wastewater Treatment

A simulation was carried out in the same manner as in Experimental Example 2, except that the concentration of dissolved oxygen diffused into a biofilm formed on the surface of the membrane was adjusted to 0.5 mg/L or less through adjustment that the average partial pressure of oxygen inside the membrane mounted in the first membrane coupled bioreactor was maintained at less than 20 kPa. As a result, it was confirmed that, even when the concentration of ammonia nitrogen in wastewater was low, the accumulation of a high concentration of nitrite nitrogen (NO₂—N) was possible due to the inhibition of nitrite oxidizing bacteria, very similar to the graph illustrated in FIG. 6.

Although the disclosure has been described with reference to the drawings and embodiments, these embodiments are provided only for illustrative purposes, and it will be understood by one of ordinary skill in the art to which the disclosure pertains that various modifications and other embodiments equivalent thereto can be made. Therefore, the true technical scope of the disclosure should be defined by the technical spirit of the appended claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A method of treating wastewater, comprising
a step (S10) of producing primary treated water by passing wastewater containing ammonia nitrogen (NH₄—N) through a first membrane coupled bioreactor,
wherein a partial region of the first membrane coupled bioreactor is operated under aerobic conditions and another region of the first membrane coupled bioreactor is operated under anoxic conditions.

2. The method of claim 1, further comprising
a step (S20) of producing secondary treated water by passing the primary treated water produced in the step (S10) through a second membrane coupled bioreactor,
wherein the second membrane coupled bioreactor is operated under anoxic conditions.

3. The method of claim 1, wherein
the step (S10) comprises a step (S10-1) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and a step (S10-2) of converting ammonia nitrogen (NH₄—N) and nitrite nitrogen (NO₂—N) into nitrogen gas (N₂) and nitrate nitrogen (NO₃-N), under anoxic conditions.

4.-8. (canceled)

9. The method of claim 2, wherein
the step (S20) comprises a step (S20-1) of converting nitrate nitrogen (NO₃—N) into nitrite nitrogen (NO₂—N), under anoxic conditions, and a step (S20-2) of converting ammonia nitrogen (NH₄—N) and nitrite nitrogen (NO₂—N) into nitrogen gas (N₂), under anoxic conditions.

10.-12. (canceled)

13. A method of treating wastewater, comprising:
a step (S100) of producing primary treated water by passing wastewater containing ammonia nitrogen (NH₄—N) through an activated sludge tank;
a step (S200) of producing secondary treated water and first sludge by passing the primary treated water through a first settling tank;
a step (S300) of producing tertiary treated water by passing the secondary treated water through a first two-stage membrane coupled bioreactor;
a step (S400) of producing quaternary treated water and second sludge by passing the tertiary treated water through a second settling tank;
a step (S500) of producing digested sludge by passing the second sludge through an anaerobic digestion tank;
a step (S600) of producing first sludge water and third sludge by passing the digested sludge through a sludge dehydration tank;
a step (S700) of producing second sludge water by passing the first sludge water through a second two-stage membrane coupled bioreactor; and
a step (S800) of mixing the second sludge water with the primary treated water supplied to the step (S200).

14. The method of claim 13, wherein
the step (S300) comprises, as steps performed in a first membrane coupled bioreactor, a step (S310) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and a step (S320) of converting ammonia nitrogen (NH₄—N) and nitrite nitrogen (NO₂-N) into nitrogen gas (N₂) and nitrate nitrogen (NO₃—N), under anoxic conditions, and comprises, as steps performed in a second membrane coupled bioreactor, a step (S330) of converting nitrate nitrogen (NO₃—N) into nitrite nitrogen (NO₂—N), under anoxic conditions, and a step (S340) of converting ammonia nitrogen (NH₄—N) and nitrite nitrogen (NO₂—N) into nitrogen gas (N₂), under anoxic conditions.

15.-16. (canceled)

17. The method of claim 13, wherein
the step (S700) comprises, as steps performed in a third membrane coupled bioreactor, a step (S710) of converting ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and a step (S720) of converting ammonia nitrogen (NH₄—N) and nitrite nitrogen (NO₂-N) into nitrogen gas and nitrate nitrogen (NO₃—N), under anoxic conditions (S720), and comprises, as steps performed in a fourth membrane coupled bioreactor, a step (S730) of converting nitrate nitrogen (NO₃—N) into nitrite nitrogen (NO₂—N), under anoxic conditions, and a step (S740) of converting ammonia nitrogen (NH₄—N) and nitrite nitrogen (NO₂—N) into nitrogen gas (N₂), under anoxic conditions.

18. The method of claim 13, wherein
the first sludge produced in the step (S200) is supplied to the anaerobic digestion tank in the step (S500).

19. The method of claim 13, wherein
part of the second sludge produced in the step (S400) is returned to the first two-stage membrane coupled bioreactor in the step (S300).

20. An apparatus for treating wastewater, comprising
a first membrane coupled bioreactor configured to produce primary treated water by treating wastewater containing ammonia nitrogen (NH₄—N),
wherein a partial region of the first membrane coupled bioreactor is operated under aerobic conditions and another region of the first membrane coupled bioreactor is operated under anoxic conditions.

21. The apparatus of claim 20, further comprising
a second membrane coupled bioreactor configured to produce secondary treated water by further treating the primary treated water produced in the first membrane coupled bioreactor, wherein the second membrane coupled bioreactor is configured to be operated under anoxic conditions.

22. The apparatus of claim 21, wherein
the first membrane coupled bioreactor is configured to primarily convert ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and to secondarily convert ammonia nitrogen (NH₄—N) and nitrite nitrogen (NO₂—N) into nitrogen gas (N₂) and nitrate nitrogen (NO₃—N), under anoxic conditions.

23. The apparatus of claim 22, wherein
the first membrane coupled bioreactor is configured such that an average partial pressure of oxygen in a membrane mounted therein is maintained in a range of about 17 kPa to about 23.2 kPa.

24. The apparatus of claim 23, wherein
the average partial pressure of oxygen in the oxygen-containing gas is controlled in conjunction with oxygen utilization efficiency and an oxygen transfer capacity that is calculated on the basis of a concentration C_{L} of dissolved oxygen in a liquid phase in equilibrium with a gas phase in the membrane through a differential pressure-based oxygen transfer model represented by Equation 1:
$$J = K \frac{\frac{{p}_{i n}}{H} - \frac{{p}_{out}}{H}}{ln ( \frac{\frac{{p}_{i n}}{H} - {C}_{L}}{\frac{{p}_{out}}{H} - {C}_{L}} )} \qquad Equation 1$$
wherein, in Equation 1,
J is oxygen transfer capacity per second (mol/m²·sec), K is mass transfer coefficient (m²/sec), Pᵢₙ is oxygen partial pressure (Pa) at an inlet, Pₒᵤₜ is oxygen partial pressure (Pa) at an outlet, H is Henry's law constant (Pa·m²/mol), and C_{L} is concentration (mol/m³) of oxygen in liquid.

25. The apparatus of claim 24, wherein
the second membrane coupled bioreactor is configured to primarily convert nitrate nitrogen (NO₃—N) into nitrite nitrogen (NO₂—N), under anoxic conditions, and to secondarily convert ammonia nitrogen (NH₄—N) and nitrite nitrogen (NO₂—N) into nitrogen gas (N₂), under anoxic conditions.

26. An apparatus for treating wastewater, comprising:
an activated sludge tank configured to produce primary treated water by treating wastewater containing ammonia nitrogen (NH₄—N) and having a chemical oxygen demand (COD);
a first settling tank configured to produce secondary treated water and first sludge by partial settling of the primary treated water;
a first two-stage membrane coupled bioreactor configured to produce tertiary treated water by further treating the secondary treated water;
a second settling tank configured to produce quaternary treated water and second sludge by partial settling of the tertiary treated water;
an anaerobic digestion tank configured to produce digested sludge by partially digesting the second sludge;
a sludge dehydration tank configured to produce first sludge water and third sludge by partially dehydrating the digested sludge; and
a second two-stage membrane coupled bioreactor configured to produce second sludge water by further treating the first sludge water.

27. The apparatus of claim 26, wherein
the apparatus is configured such that the second sludge water is mixed with the wastewater supplied to the first settling tank.

28. The apparatus of claim 26, wherein
the first two-stage membrane coupled bioreactor comprises a first membrane coupled bioreactor and a second membrane coupled bioreactor that are connected to each other in series,
the second two-stage membrane coupled bioreactor comprises a third membrane coupled bioreactor and a fourth membrane coupled bioreactor that are connected to each other in series,
each of the first membrane coupled bioreactor and the third membrane coupled bioreactor is configured to primarily convert ammonia nitrogen (NH₄—N) into nitrite nitrogen (NO₂—N), not into nitrate nitrogen (NO₃—N), through partial oxidization of the ammonia nitrogen (NH₄—N), under aerobic conditions, and to secondarily convert ammonia nitrogen (NH₄—N) and nitrite nitrogen (NO₂—N) into nitrogen gas and nitrate nitrogen (NO₃—N), under anoxic conditions, and
each of the second membrane coupled bioreactor and the fourth membrane coupled bioreactor is configured to primarily convert nitrate nitrogen (NO₃—N) into nitrite nitrogen (NO₂—N), under anoxic conditions, and to secondarily convert ammonia nitrogen (NH₄—N) and nitrite nitrogen (NO₂—N) into nitrogen gas (N₂), under anoxic conditions.

29.-30. (canceled)

31. The apparatus of claim 26, wherein
the apparatus is configured such that the first sludge produced in the first settling tank is supplied to the anaerobic digestion tank.

32. The apparatus of claim 26, wherein
the apparatus is configured such that part of the second sludge produced in the second settling tank is returned to the first two-stage membrane coupled bioreactor.
